(19) United States
(12) Patent Application Publication
(10) Pub. No.: US 2025/0212065 A1
(43) Pub. Date: Jun. 26, 2025

(54) METHOD AND APPARATUS FOR APPLICATION CONTEXT RELOCATION PROCEDURE IN AN EDGE DATA NETWORK

(71) Applicant: Samsung Electronics Co., Ltd., Suwon-si, Gyeonggi-do (KR)

(72) Inventors: Sapan Pramodkumar SHAH, Bangalore (IN); Narendranath Durga TANGUDU, Bangalore (IN); Basavaraj Jayawant PATTAN, Bangalore (IN); Hyesung KIM, Suwon-si (KR)

(21) Appl. No.: 18/850,366

(22) PCT Filed: Mar. 27, 2023
(86) PCT No.: PCT/KR2023/004039

§ 371 Date: Sep. 24, 2024

(30) Foreign Application Priority Data
Mar. 28, 2022 (IN) 202241017998
Dec. 29, 2022 (IN) 2022 41017998

(51) Int. Cl. H04W 36/00

(52) U.S. Cl. CPC H04W 36/0033

(57) ABSTRACT

The disclosure relates to a 5G or 6G communication system for supporting a higher data transmission rate. a method for managing an application context relocation (ACR) procedure by an edge enabler server (EES) in an edge data network is provided. The method comprises identifying that a first ACR procedure is initiated; and based on the first ACR procedure being initiated, sending a first notification message indicating a start of the first ACR procedure to a first entity in the edge data network. Upon receiving the first notification message, the first entity does not trigger execution of a second ACR procedure until the first ACR procedure is completed.

### CROSS-REFERENCE TO RELATED APPLICATION(S)

This application is a U.S. National Stage application under 35 U.S.C. § 371 of an International application number PCT/KR2023/004039, filed on Mar. 27, 2023, which is based on and claims priority of an Indian Provisional Patent Application No. 20/224,1017998, filed on Mar. 28, 2022, in the Indian Intellectual Property Office, and of an Indian Non-Provisional patent application Ser. No. 20/224,1017998, filed on Dec. 29, 2022, in the Indian Intellectual Property Office, the disclosure of each of which is incorporated by reference herein in its entirety.

### TECHNICAL FIELD

The present disclosure relates to a method and an apparatus for managing an application context relocation (ACR) procedure by an edge enabler server (EES) in an edge data network, and more specifically to single service continuity procedure execution.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Fifth Generation (5G) cellular network is deployed with an expectation to increase data transmission speed by multiple times compared to previous generation cellular networks, still the 5G cellular network also subjected to a latency the data transmission. In order to reduce the latency, edge computing is introduced for the 5G cellular network which brings computing resources near to users. In release-17, Third Generation Partnership Project (3GPP) has defined Edge Enabler Layer (EEL) in Technical Specification (TS) 23.558. The EEL exposes Application Programming Interfaces (APIs) to support capabilities like service provisioning, registration, application server discovery, capability exposure to an Application Server (AS), and support for service continuity. The Application Clients (ACs) in a User Equipment (UE) are able to locate and connect with a most suitable Edge Application Server (EAS) available in an Edge Data Network (EDN), using capabilities provided by the EEL.

In EEL, the EAS serves the UE based on UE's location. When the UE moves from one location to a new location, then the EAS which is connected to the AC in the UE needs to be replaced with another EAS depending on the new location, to provide a better service experience to the users and the UE. The EEL provides a service continuity feature for minimizing an application layer service interruption. In the 3GPP TS 23.558 for the release-17, the service continuity feature is supported by defining information elements and procedures for an Application Context Relocation (ACR). The ACR procedures enable the transfer of EEC context from one Edge Enabler Server (EES) i.e. Source EES (S-EES) to another EES i.e. Target EES (T-EES), and the transfer of application context from one Edge Application Server (EAS) i.e. Source EAS (S-EAS) to another EAS i.e. Target EAS (T-EAS) and are used in different scenarios as specified in the 3GPP TS 23.558.

The current specification in the 3GPP TS 23.558 enables multiple entities (e.g. AC, EEC, EAS, EES) supporting different service continuity scenarios to concurrently detect a need for the ACR, decide whether the ACR is required or not, and finally execute the ACR procedure. It is required for the multiple entities to detect the need for the ACR in order to transfer a EEC context and an application context on time to the target EES and a target EAS respectively on time. However if an ACR execution followed by the detection of the ACR is performed concurrently by the multiple entities then the ACR procedure is bound to fail (as ACR may be concurrently executed towards different T-EASs) and the users will experience service interruption. Hence, a solution is desired to ensure single ACR execution upon detecting the need for the ACR at the multiple entities.

### DISCLOSURE

### Technical Solution

The principal object of the embodiments herein is to provide a method and an Edge Enabler Server (EES) for single service continuity procedure execution. Multiple detection entities can detect the need for a ACR however only one ACR procedure remains in the execution phase using the proposed method which increases the end user experience and service satisfaction.

According to an aspect of the present disclosure, a method for managing an application context relocation (ACR) procedure by an edge enabler server (EES) in an edge data network is provided. The method comprises identifying that a first ACR procedure is initiated; and based on the first ACR procedure being initiated, sending a first notification message indicating a start of the first ACR procedure to a first entity in the edge data network. Upon receiving the first notification message, the first entity does not trigger execution of a second ACR procedure until the first ACR procedure is completed.

According to an aspect of the present disclosure, an apparatus of an edge enabler server (EES) for managing an application context relocation (ACR) procedure is provided. The apparatus comprises a memory and at least one processor coupled to the memory. The at least one processor is configured to identify that a first ACR procedure is initiated; and based on the first ACR procedure being initiated, send a first notification message indicating a start of the first ACR procedure to a first entity in the edge data network. Upon receiving the first notification message, the first entity does not trigger execution of a second ACR procedure until the first ACR procedure is completed.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### DESCRIPTION OF DRAWINGS

This disclosure is illustrated in the accompanying drawings, throughout which like reference letters indicate corresponding parts in the various figures. The embodiments herein will be better understood from the following description with reference to the drawings, in which:

FIG. 1 is a block diagram of an EES for single service continuity procedure execution, according to an embodiment as disclosed herein;

FIG. 2 is a flow diagram illustrating a method for single service continuity procedure execution by the EES, according to an embodiment as disclosed herein;

FIG. 3 is a sequence diagram illustrating signaling of the EES for indicating a start of a ACR to a primary decision making entity, according to an embodiment as disclosed herein; and

FIG. 4 is a sequence diagram illustrating signaling of the EES for notifying about an ongoing ACR to other decision-making entities, according to an embodiment as disclosed herein.

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

An Edge Enabler Layer (EEL), defined in 3GPP TS 23.558, exposes APIs to support capabilities like service provisioning, registration, application server discovery, capability exposure to an Application Server (AS), and support for service continuity. An Edge Enabler Client (EEC) and an Edge Enabler Server (EES) provide client and server-specific functionalities of the EEL respectively. An Edge Application Server (EAS) serves the Application Clients (ACs) in a User Equipment (UE). The EAS deployed in an Edge Data Network (EDN) registers itself with the EES of the EDN. The EEC also registers itself with the EES in order to support the ACs in the UE. When the EEC registers itself with the EES, then the EES creates an EEC context for the EEC. The ACs in the UE are able to locate and connect with the most suitable EAS available in the EDN), using the capabilities provided by the EEL.

In the EEL, the EAS serves the ACs in the UE based on UE's location. When the UE moves from one location to a new location, the EAS with which the AC is connected (i.e. the most suitable EAS to serve the AC in the current location of the UE) may not remain the most suitable EAS in the UE's new location area. So, the EAS with which the AC is connected needs to be replaced with another EAS depending on the new location, to provide a better service experience to a user and UE. The EAS with which the AC is connected to and receiving service in the UE's current location is called a Source EAS (S-EAS). The EAS with which the AC will be connected to receive the service in the UE's new location is called a Target EAS (T-EAS). The EES with which the EEC and the S-EAS are registered is called a Source EES (S-EES). The EES with which the T-EAS is registered and the EEC will be registered in order to receive service, is called a Target EES (T-EES).

The service continuity feature is supported by the EEL by specifying information elements and procedures for an Application Context Relocation (ACR). The ACR procedures enable the transfer of a EEC context from one EES (i.e. S-EES) to another EES (T-EES) and the transfer of application context from one EAS (i.e. S-EAS) to another EAS (i.e. T-EAS). As per 3GPP TS 23.558, multiple entities (AC, EEC, EAS, EES) can concurrently detect the need for the ACR, decide whether ACR is required or not, and finally execute the ACR procedure. The multiple detection entities are required in order to detect the need for the ACR as early as possible and to transfer the EEC context and an application context to the T-EES and the T-EAS respectively on time. However, if the ACR execution is performed concurrently by multiple entities then the ACR procedure is bound to fail and the user will experience service interruption.

In 3GPP TR 23.700-98, 3GPP proposes a solution where the EES determines one selected ACR scenario. The EEC registers itself with the EES indicating the supported service continuity scenarios for the EEC. The EAS also registers itself with the EES which also includes the supported service continuity scenarios for the EAS. At the time of EAS discovery, the EEC provides a list of AC profiles available at the UE. So, the EES has the information about the supported service continuity scenarios of all entities (AC, EEC, EAS, and EES). As per the solution, upon receiving the EAS discovery request from the EEC, the EES determines one suitable ACR scenario for the AC based on the ACR scenarios supported by the AC, the EEC, the EES, and the EAS. The EES can select an appropriate ACR scenario for the AC from the intersection of the ACR scenarios supported by the AC, the EEC, the EES, and the EAS. The EES shares the selected one suitable ACR scenario for the AC to the EAS via a notification and to the EEC in the EAS discovery response.

This existing solution works on the assumption that there exists at least one scenario from the intersection of the ACR scenarios supported by the AC, the EEC, the EES, and the EAS. It is possible that there is no common scenario exists from the intersection of the ACR scenarios supported by all the entities (AC, EEC, EES, and EAS). So, the existing solution does not work in case if no common scenario exists from the intersection of the ACR scenarios supported by all the entities. Further, as per the existing solution, the EES determines one suitable ACR scenario for the AC from the intersection of the ACR scenarios supported by the AC, the EEC, the EES, and the EAS. It may be possible that a detection entity of the one selected ACR scenario may not be able to detect the ACR on time which may lead to service interruption.

As per the existing solution, the EES determines one suitable ACR scenario and informs the same to EEC (in EAS discovery response) and EAS (in AC information notification). Now, if the UE moves and the ACR actually occurs based on the one selected ACR scenario, and if the T-EES or T-EAS don't support the one selected ACR scenario, then service continuity will fail. Further, during some of the scenarios for the service continuity as specified in the TS 23.558, it is possible for the T-EES to perform implicit registration of the EEC. The existing solution does not specify the procedure using which the T-EES will be made aware of the supported service continuity scenarios of the EEC.

The proposed method allows the multiple detection entities to detect the need for the ACR and allows only one ACR procedure to remain in an execution phase.

Accordingly, the embodiments herein provide a method for single service continuity procedure execution in an Edge Enabler Server (EES). The method includes detecting, by the EES in an edge data network, a start of a first Application Context Relocation (ACR) procedure. Further, the method includes sending, by the EES, a first notification message indicating the start of the first ACR procedure to a second entity in the edge data network, where the second entity does not trigger a second ACR procedure until the completion of first ACR procedure.

Accordingly, the embodiments herein provide the EES for the single service continuity procedure execution. The EES includes an ACR procedure trigger controller, a memory, a processor, where the ACR procedure trigger controller is coupled to the memory and the processor. The ACR procedure trigger controller is configured for detecting the start of the first ACR procedure. The ACR procedure trigger controller is configured for sending the first notification message indicating the start of the first ACR procedure to the second entity in the edge data network, where the second entity does not trigger the second ACR procedure until the completion of first ACR procedure.

The EES determines one suitable ACR scenario for the AC based on the ACR scenarios supported by the AC, the EEC, the EES, and the EAS, if there exists at least 1 common service continuity scenario supported by all entities (i.e. AC, EEC, EES, and EAS). A decision-making entity of the selected one scenario, is considered a primary decision-making entity. If the ACR is triggered, then the EES informs the primary decision-making entity about the initiation of the ACR procedure, and further the primary decision-making entity decides whether to proceed with the ACR or not by accepting or rejecting the request from the EES. If there is no common service continuity scenario supported by all entities (i.e. AC, EEC, EES, and EAS), then the EES act as the primary decision-making entity.

The EES informs the EEC or the EAS about the start of the ACR if the EEC or the EAS has not initiated the ACR. The EES informs the completion of the ACR to the EEC or the EAS if the EEC or the EAS has not initiated the ACR. The EEC or the EAS stops triggering a new ACR upon receiving a notification from the EES about start of the ACR, till the ACR execution is in progress. The EEC or the EAS starts a timer upon receiving the notification (i.e. first notification message) from the EES about the start of the ACR by another entity. The EEC or the EAS terminates the timer upon receiving the notification from the EES about the completion of the ACR by another entity. The EEC or the EAS is ready to trigger a new ACR upon expiry of the timer.

Two methods are proposed in this disclosure to ensure that only one ACR procedure remains in the execution phase. In first method, a primary decision making entity is considered based on common ACR scenarios supported by multiple EEL entities, and once an ACR execution is started, the EES indicates a start of ACR to the primary decision making entity which decides whether to allow the ACR for the execution phase or not. The EES notifies the primary decision making entity about the start of ACR by different decision making entity. The primary decision making entity takes decision whether to accept or reject the request for the ACR execution. The EEC or the EAS starts the timer upon receiving the notification from the EES about the start of the ACR by another entity, the EEC or the EAS is ready to trigger a new ACR upon expiry of the timer.

In second method, the EES notifies about the ongoing ACR to other decision-making entities (there is no-primary decision making entity concept).i.e. the EES notifies the EEC about start of the ACR, if the ACR is initiated by the EAS or the EES. Also, the EES notifies the EAS about start of the ACR, if the ACR is initiated by the EEC or the EES. Upon receiving the notification, the EEC or the EAS stops triggering another ACR for same AC-EAS pair until the already initiated ACR execution is completed.

Receiving continues service in an edge data network is one of the important aspect of any deployment. In existing method, for service continuity procedures, multiple decision-making entities can trigger the ACR execution which will lead to service failure and end user will experience service interruption. The proposed method solves this critical problem and enhances EEL entities' behaviour such that only one ACR remains in execution phase and the UE can continue receiving service from edge data network, which increases the end user experience and service satisfaction.

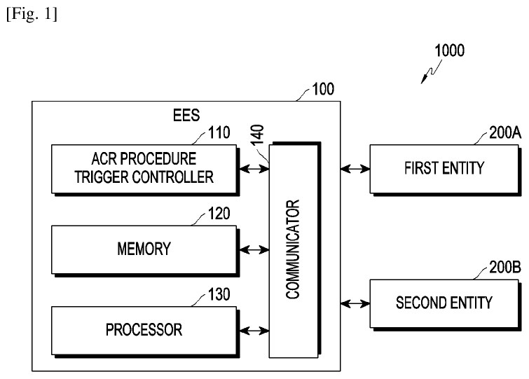

Referring now to the drawings, and more particularly to FIGS. 1 through 4, there are shown preferred embodiments.

FIG. 1 is a block diagram of an Edge Enabler Server (EES) (100) for single service continuity procedure execution, according to an embodiment as disclosed herein. In an embodiment, a system (1000) includes the EES (100), a first entity (200A), and a second entity (200B) of the edge data network.

In an embodiment, the first entity (200A) is at least one of an Edge Enabler Client (EEC), an Edge Application Server (EAS) and the EES (100). In another embodiment, the second entity (200B) is at least one of the EEC, the EAS, and the EES (100). In an embodiment, when the EEC operates as the first entity (200A) then the EAS operates as the second entity (200B). In another embodiment, when the EAS operates as the first entity (200A) then the EEC operates as the second entity (200B). In another embodiment, when the EES (100) operates as the first entity (200A) then the EAS and the EEC operate as the second entity (200B). In another embodiment, when the EEC operates as the first entity (200A), then the EES (100) sends an ACR management event notification with an ACT start event as the first notification message to the EAS. In another embodiment, when the EAS operates as the first entity (200A), then the EES (100) sends an ACR information notification as the first notification message to the EEC. In another embodiment, when the EES (100) operates as the first entity (200A), then the EES (100) sends an ACR management event notification with an ACT start event as the first notification message to the EAS and the ACR information notification as the first notification message to the EEC.

In an embodiment, the EES (100) includes a ACR procedure trigger controller (110), a memory (120), a processor (130), and a communicator (140). The ACR procedure trigger controller (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like. The ACR procedure trigger controller (110) and the processor (130) may be integrally referred to as at least one processor.

The ACR procedure trigger controller (110) detects a start of a first ACR procedure. Further, the ACR procedure trigger controller (110) sends a first notification message indicating the start of the first ACR procedure to the second entity (200B) in the edge data network, where the second entity (200B) does not trigger a second ACR procedure until the completion of first ACR procedure. In an embodiment, the first notification message includes an identity of an Application Client (AC) and an identity of EAS endpoints.

The second entity (200B) starts a timer upon receiving the first notification message indicating the start of the first ACR procedure from the EES (100).

In an embodiment, the ACR procedure trigger controller (110) detects a completion of the first ACR procedure, where the completion of the first ACR procedure includes one of success or failure of the first ACR procedure. Further, the ACR procedure trigger controller (110) sends a second notification message includes success or failure of the first ACR procedure to the second entity (200B), where the second entity (200B) does not trigger the second ACR procedure until the second entity (200B) receives the second notification message indicating the completion of the first ACR procedure from the EES or until the timer expires.

In an embodiment, for detecting the start of the first ACR procedure, the ACR procedure trigger controller (110) receives a request to initiate and/or determine the first ACR procedure from the first entity (200A). Further, the ACR procedure trigger controller (110) initiates a request for application context transfer. Further, the ACR procedure trigger controller (110) detects need for the first ACR procedure.

In an embodiment, for detecting the start of the first ACR procedure, the ACR procedure trigger controller (110) receives an EAS discovery request from the EEC. Further, the ACR procedure trigger controller (110) determines one suitable ACR scenario for an AC and EAS pair based on the ACR scenarios supported by the AC, the EEC, the EES (100), and the EAS. Further, the ACR procedure trigger controller (110) determines a decision making entity of the selected one ACR scenario as a primary decision making entity. Further, the ACR procedure trigger controller (110) sends the selected ACR scenario in the EAS discovery response. Further, the ACR procedure trigger controller (110) receives a request to initiate or determine the first ACR procedure from at least one of the decision making entity of the supported ACR scenarios. Further, the ACR procedure trigger controller (110) sends a request message to the primary decision-making entity of the selected one scenario about the initiation of the first ACR procedure. Further, the ACR procedure trigger controller (110) receives a response message containing decision of the primary decision-making entity whether to proceed with the first ACR procedure or not.

The memory (120) stores instructions to be executed by the processor (130). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the EES (100), a cloud storage, or any other type of external storage.

The processor (130) is configured to execute instructions stored in the memory (120). The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) is configured for communicating internally between hardware components in the EES (100). Further, the communicator (140) is configured to facilitate the communication between the EES (100) and other devices via one or more networks (e.g. Radio technology). The communicator (140) includes an electronic circuit specific to a standard that enables wired or wireless communication.

Although the FIG. 1 shows the hardware components of the system (1000) but it is to be understood that other embodiments are not limited thereon. In other embodiments, the system (1000) may include less or a greater number of components. Further, the labels or names of the components are used only for illustrative purpose and does not limit the scope of the disclosure. One or more components can be combined together to perform same or substantially similar function for the single service continuity procedure execution.

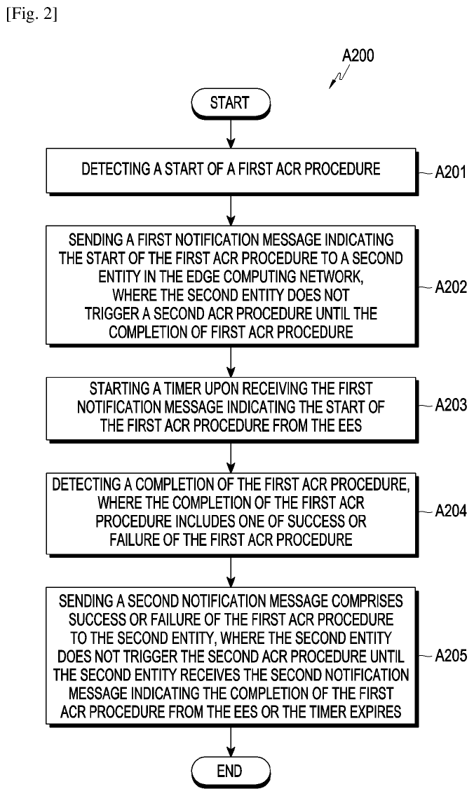

FIG. 2 is a flow diagram (A200) illustrating a method for the single service continuity procedure execution by the EES (100), according to an embodiment as disclosed herein. In an embodiment, the method allows the ACR procedure trigger controller (110) to perform steps A201, A202, 204 and A205 of the flow diagram (A200). At step A201, the method includes detecting the start of the first ACR procedure. At step A202, the method includes sending the first notification message indicating the start of the first ACR procedure to the second entity in the edge data network, where the second entity does not trigger the second ACR procedure until the completion of first ACR procedure. At step A203, the method includes starting the timer upon receiving the first notification message indicating the start of the first ACR procedure from the EES (100). In an embodiment, the method allows the second entity (200B) to start the timer upon receiving the first notification message indicating the start of the first ACR procedure from the EES (100).

At step A204, the method includes detecting the completion of the first ACR procedure, where the completion of the first ACR procedure includes one of success or failure of the first ACR procedure. At step A205, the method includes sending the second notification message comprises the success or the failure of the first ACR procedure to the second entity (200B), where the second entity (200B) does not trigger the second ACR procedure until the second entity (200B) receives the second notification message indicating the completion of the first ACR procedure from the EES (100) or until the timer expires.

The various actions, acts, blocks, steps, or the like in the flow diagram (300) may be performed in the order presented, in a different order, or simultaneously. Further, in some embodiments, some of the actions, acts, blocks, steps, or the like may be omitted, added, modified, skipped, or the like without departing from the scope of the disclosure.

FIG. 3 is a sequence diagram illustrating signaling of the EES (100) for indicating the start of the ACR to the primary decision making entity, according to an embodiment as disclosed herein. A detection entity detects a probable need for the ACR by monitoring various aspects, such as UE's location or predicted/expected UE location and further indicates to the decision-making entity to determine if the ACR is required. The EEC, the EES (100) and the EAS can potentially perform the detection role. A decision making entity determines that the ACR is required and instructs an execution entity to perform the ACR, where the execution entity performs the ACR as and when instructed by the decision making entity.

Upon receiving the EAS discovery request from the EEC, the EES (100) determines one suitable ACR scenario for the AC based on the ACR scenarios supported by the AC, the EEC, the EES (100), and the EAS. If there exists at least 1 common service continuity scenario supported by all the entities (i.e. AC, EEC, EES (100), and EAS). The EES (100) can select an appropriate ACR scenario for the AC from the intersection of the ACR scenarios supported by the AC, the EEC, the EES (100), and the EAS. The EES (100) shares the selected one suitable ACR scenario for the AC to the EAS via a notification and to the EEC in the EAS discovery response.

If there exists at least 1 common service continuity scenario supported by all entities (i.e. AC, EEC, EES (100), and EAS), the decision-making entity of the selected one scenario, is considered as a primary decision-making entity. The detection entities of all other supported scenarios by the AC, the EEC, the EES (100), and the EAS will continue to detect the need for the ACR and may trigger the ACR. If the ACR is triggered by the entity other than the primary decision making entity, the EES (100) informs the primary decision-making entity about the initiation of the ACR procedure. If there is no common service continuity scenario supported by all entities (i.e. AC, EEC, EES (100), and EAS), then the EES (100) act as the primary decision-making entity.

In an embodiment, the EES (100) determines one or more suitable ACR scenario for the AC based on the ACR scenarios supported by the AC, the EEC, the EES (100), and the EAS. If there exists more than one common service continuity scenario supported by all entities (i.e. AC, EEC, EES (100), and EAS). In such a case, the EES (100) determines the primary decision-making entity.

Procedure to indicate primary decision making entity: In order to avoid the ACR procedure being overlapped, when the decision making entity of the ACR scenario (which is not the one selected ACR scenario for the AC) triggers the ACR, the EES (100) indicates the primary decision making entity of the one selected ACR scenario about the initiation of the ACR.

At step 301, based on the information received from the detection entity, the decision-making entity (200A) of the ACR scenario (which is not the one selected ACR scenario for the AC) requests to initiate the ACR to the EES (100). At step 302, the EES (100) identifies that the request to initiate the ACR is not from the primary decision-making entity (300B) and indicates the initiation of the ACR to the primary decision-making entity. At step 303, the primary decision-making entity (300B) sends a response to the EES (100) indicating accept or reject for the request. The primary decision-making entity (300B) rejects the request to initiate the ACR only if there is already ongoing ACR. If the primary decision-making entity (300B) is the EES (100) then steps 302 and 303 are skipped. At step 304, the EES (100) sends a response to the decision-making entity (200A) who initiated the ACR in the step 1 indicating accept or reject of the request. At step 305, if the primary decision-making entity (300B) has accepted the request to initiate the ACR, then the EES (100) performs the ACR as per the scenario specified in clause 8.8 of TS 23.558. Steps 304 and step 305 can happen in parallel and in any order.

In an embodiment, the decision-making entity or detection entity (200A) can be the AC or the EEC or the EAS or the EES (100) or like so. In another embodiment, the primary decision-making entity (300B) can be the AC or the EEC or the EAS or the EES (100) or like so. In an embodiment, if there is no ACR execution already ongoing, then the step 305 can be performed in parallel to the step 302.

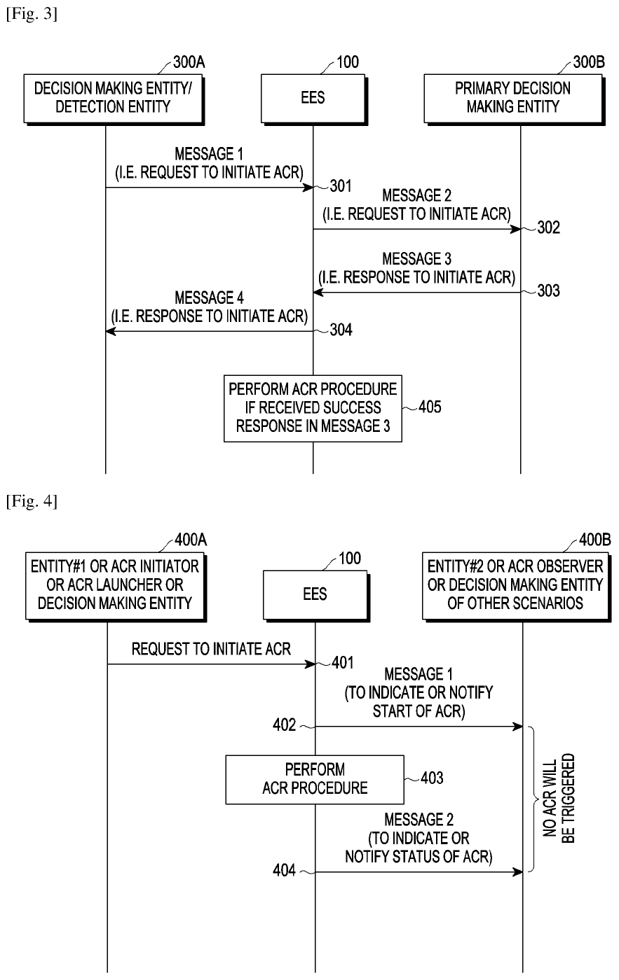

FIG. 4 is a sequence diagram illustrating signaling of the EES (100) for notifying about the ongoing ACR to other decision-making entities, according to an embodiment as disclosed herein. The decision-making entity (400A) of any supported scenario triggers the ACR, however once the ACR procedure is triggered, then the EES (100) notifies the decision-making entities (400B) of other scenario(s) about the start of the ACR. Once the ACR procedure is completed, the EES (100) notifies the decision-making entities (400B) of other scenario(s) about the completion of the ACR (success or failure). The decision-making entities (400B) of other scenario(s) shall not trigger the ACR till one ACR procedure is in progress and notification about the completion of the ACR is received. The decision-making entity (or entities) (400B) of all supported service continuity scenarios subscribe to the EES (100) for information about the start and completion of ACR by other entities.

In an embodiment, the decision-making entity (400A) can be the AC or the EEC or the EAS or the EES (100) or like so. In an embodiment, the EEC subscribes to the EES (100) for information about the status of the ACR (i.e. whether ACR is started or completed) initiated by the EES (100) or the EAS, and similarly, the EAS subscribes to the EES (100) for information about the status of the ACR (i.e. whether ACR is started or completed) initiated by the EES (100) or the EEC. In an embodiment, an entity #1 (or ACR initiator entity or ACR launcher entity or the decision-making entity or functional entity #1) can be the EEC or the EAS or the EES (100). In an embodiment, an entity #2 (or ACR observer entity or the decision-making entity of other scenarios or functional entity #2) can be the EEC or the EAS, or the EES (100).

In an embodiment, if the EEC sends the request to initiate the ACR by acting as the entity #1, then the EAS is considered as the entity #2. If the EAS sends the request to initiate the ACR by acting as the entity #1, then EEC is considered as the entity #2. If the EES (100) acts as the entity #1, then both the EAS and the EEC are considered as the entity #2.

At step 401, based on the information received from the detection entity, the entity #1 (the decision making entity of an ACR scenario) (400A) requests to initiate the ACR to the EES (100). The request may include the reason to initiate the ACR along with other parameters as specified in 3GPP TS 23.558. The step 401 is not performed if the EES (100) is the decision-making entity. At step 402, the EES (100) notifies the entity #2 (i.e. the decision-making entity of the other scenarios) (400B) about the start of the ACR. Upon receiving this notification, the entity #2 (i.e. the decision-making entity of the other scenarios) shall not initiate the new ACR for the same AC and EAS pair until the ongoing ACR is completed. The notification may include the reason to initiate the ACR along with the identity of the ACR scenario. The notification also includes the identity of the AC and EAS endpoints.

In an embodiment, the EES (100) notifies the enity #2 (i.e. the decision-making entity of the other scenarios) about the start of the ACR if the entity #2 has not initiated another concurrent ACR request. In an embodiment, if the request to initiate the ACR is triggered by the EEC, then the EES (100) notifies the EAS about the start of the ACR initiated by the EEC. In an embodiment, if the request to initiate the ACR is triggered by the EAS, then the EES (100) notifies the EEC about the start of the ACR initiated by the EAS. In an embodiment, if the ACR is triggered by the EES (100), then the EES (100) notifies the EAS and the EEC about the start of the ACR initiated by the EES (100). At step 403, the EES (100) performs the ACR procedure as per the scenario as specified in clause 8.8 of 3GPP TS 23.558. At step 404, the EES (100) notifies the completion of the ACR to the entity #2 (i.e. the decision-making entity of the other scenarios).

In an embodiment, the entity #2 starts the timer upon receiving the notification from the EES (100) about the start of the ACR initiated by the entity #1. The entity #2 terminates the timer upon receiving the notification from the EES (100) about the completion of the ACR which was initiated by entity #1. The entity #2 may initiate a new ACR upon expiry of the timer (that is the notification about the completion of the ACR which was initiated by the entity #1 is not received in a specified time).

In an embodiment, if the request to initiate the ACR was triggered by the EEC, then the EES (100) notifies the EAS about the completion of the ACR which was initiated by the EEC. In an embodiment, if the request to initiate the ACR was triggered by the EAS, then the EES (100) notifies the EEC about the completion of the ACR which was initiated by the EAS. In an embodiment, if the ACR was triggered by the EES (100), then the EES (100) notifies the EAS and the EEC about the completion of the ACR which was initiated by the EES (100).

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for managing an application context relocation (ACR) procedure by an edge enabler server (EES) in an edge data network, the method comprising:
identifying that a first ACR procedure is initiated; and
based on the first ACR procedure being initiated, sending a first notification message indicating a start of the first ACR procedure to a first entity in the edge data network,
wherein upon receiving the first notification message, the first entity does not trigger execution of a second ACR procedure until the first ACR procedure is completed.

2. The method of claim 1, wherein the first notification message includes an identify of an application client (AC) and at least one EAS endpoint, and
wherein the second ACR procedure corresponds to the identity of the AC and the at least one EAS endpoint.

3. The method of claim 1, wherein the first entity is one of an edge enabler client (EEC), an edge application server (EAS) and the EES.

4. The method of claim 1, wherein the first ACR procedure is initiated by a second entity.

5. The method of claim 4, wherein the second entity is one of an edge enabler client (EEC), an edge application server (EAS) and the EES.

6. The method of claim 4, wherein when an edge enabler client (EEC) operates as the second entity, an edge application server (EAS) operates as the first entity.

7. The method of claim 6, wherein when the EEC operates as the second entity, the EES sends an ACR management event notification with an ACT start event as the first notification message to the EAS.

8. The method of claim 4, wherein when an edge application server (EAS) operates as the second entity, an edge enabler client (EEC) operates as the first entity.

9. The method of claim 8, wherein when the EAS operates as the second entity, the EES sends an ACR information notification as the first notification message to the EEC.

10. The method of claim 4, wherein when the EES operates as the second entity, an edge application server (EAS) or an edge enabler client (EEC) operate as the first entity.

11. The method of claim 10, wherein when the EES operates as the second entity, the EES sends an ACR management event notification with an ACT start event as the first notification message to the EAS and the ACR information notification as the first notification message to the EEC.

12. The method of claim 1, further comprising:
detecting a completion of the first ACR procedure, wherein the completion of the first ACR procedure includes one of success or failure of the first ACR procedure; and
sending a second notification message indicating the completion of the first ACR procedure to the first entity, wherein the first entity does not trigger the second ACR procedure until the first entity receives the second notification message indicating the completion of the first ACR procedure from the EES (100) or until a timer which was started upon receiving the first notification message expires.

13. The method of claim 1, further comprising:
receiving an edge application server (EAS) discovery request from an edge enabler client (EEC);
determining a ACR scenario for an application client (AC) and EAS pair based on ACR scenarios supported by an AC, the EEC, the EES, and an EAS;
determining a decision making entity of the determined ACR scenario as a primary decision making entity;
sending the determined ACR scenario in an EAS discovery response;
receiving a request to initiate or determine the first ACR procedure from at least one of decision making entities of the supported ACR scenarios;
sending a request message to a primary decision-making entity of the determined ACR scenario about an initiation of the first ACR procedure; and
receiving a response message containing decision of the primary decision-making entity whether to proceed with the first ACR procedure or not.

14. An apparatus of an edge enabler server (EES) for managing an application context relocation (ACR) procedure, the apparatus comprising:
a memory; and
at least one processor coupled to the memory, wherein the at least one processor is configured to:
identify that a first ACR procedure is initiated, and
based on the first ACR procedure being initiated, send a first notification message indicating a start of the first ACR procedure to a first entity in the edge data network,
wherein upon receiving the first notification message, the first entity does not trigger execution of a second ACR procedure until first ACR procedure is completed.

15. The apparatus of claim 14,
wherein the first notification message includes an identify of an application client (AC) and at least one EAS endpoint, and
wherein the second ACR procedure corresponds to the identity of the AC and the at least one EAS endpoint.

16. The apparatus of claim 14, wherein the first entity is one of an edge enabler client (EEC), an edge application server (EAS) and the EES.

17. The apparatus of claim 14,
wherein the first ACR procedure is initiated by a second entity, and
wherein the second entity is one of an edge enabler client (EEC), an edge application server (EAS) and the EES.

18. The apparatus of claim 17, wherein, when the EEC operates as the second entity, the EAS operates as the first entity, and the EES sends an ACR management event notification with an ACT start event as the first notification message to the EAS.

19. The apparatus of claim 17, wherein, when the EAS operates as the second entity, the EEC operates as the first entity, and the EES sends an ACR information notification as the first notification message to the EEC.

20. The apparatus of claim 17, wherein, when the EES operates as the second entity, the EAS or the EEC operate as the first entity, and the EES sends an ACR management event notification with an ACT start event as the first notification message to the EAS and the ACR information notification as the first notification message to the EEC.
